(19) United States
(12) Patent Application Publication
(10) Pub. No.: US 2007/0240186 A1
(43) Pub. Date: Oct. 11, 2007

(54) Program Selection System

(75) Inventors: Yonatan Silver, Jerusalem (IL); Avidan Lamdan, Tzur Hadassah (IL); Boaz Rahat, Jerusalem (IL)

Correspondence Address: WELSH & KATZ, LTD, 120 S RIVERSIDE PLAZA, 22ND FLOOR, CHICAGO, IL, 60606, US

(73) Assignee: NDS Limited, Middlesex UB 7 0DQ (GB)

(21) Appl. No.: 11/632,536

(22) PCT Filed:
(86) PCT No.: PCT/IL04/01003

Related U.S. Application Data
(60) Provisional application No. 60/602,213, filed on Aug. 17, 2004.

(51) Int. Cl. G06F 3/00

(52) U.S. Cl. 725/39

(57) ABSTRACT

A method and system for enabling a user to select programs in a personal video recorder environment, the method comprising enabling the user to select a program subject category, providing in response to user selection of a program subject category, for subsequent user selection, programs within said selected program subject category, at least one of selected and organized in accordance with past user viewing, and subsequently enabling the user to select among said programs. Related methods and apparatus are also described.

### CROSS REFERENCE TO RELATED APPLICATION

The present application claims priority from U.S. Provisional Patent Application 60/602,213, of Silver, et al., filed 17 Aug. 2004, the disclosure of which is hereby incorporated by reference.

### FIELD OF THE INVENTION

The present invention relates to television technology, and more specifically, but not exclusively, set top box technology.

### BACKGROUND OF THE INVENTION

Published US Patent Application 2004/0021640 of Lee describes a method for associating a number of channels, preferably with a common theme, with a single button on a remote control and using this button together with the up/down arrow keys to scroll through these channels. A user is restricted to channels and the choice of channels remains fixed until changed by the user.

U.S. Pat. No. 6,401,059 to Shen et al. describes a method of making program guide information available on a personal digital assistant (PDA). Using user defined preferences, such as title, actor, category, and so forth, a user can perform queries on the program guide scheduling information. Having determined the desired information, the user can cause the PDA to send an appropriate signal to a device such as a television, set-top box, or personal video recorder to display or record, as appropriate, the selected program.

Published PCT application WO 03/054826 of Koninklijke Philips Electronics N.V. describes a system allowing a user of a single remote control to adapt, in advance of use, the meaning of each of the buttons and/or to initiate a series of commands depending on the overall activity being performed. A storage device is used to store user defined mappings for each activity and for each user.

Published PCT application WO 01/074051 of Diego Broadband Inc. describes a method of displaying multimedia content on a display area of a broadband Internet-enabled television system including providing a remote control to control contents being displayed on the display area. A first instruction transmitted by the remote control in response to activation of a first button is received. A first synthetic channel page is displayed in response to the first instruction. The first synthetic channel page includes a television content section and an Internet content section.

Published PCT application WO 02/007122 of Universal Electronics Inc. describes a customizable and upgradeable remote control that may be customized or upgraded via a web site or through other remote, and preferably interactive, processes. A database is provided that includes a plurality of functions of a consumer electronic device, such as a TV or DVD player. A user selects at least one of the desired functions. In response, a virtual configuration is created to virtually configure the customized remote control. The virtual configuration may be downloaded to the customizable remote control.

U.S. Pat. No. 6,637,029 to Maissel et al. describes a subscriber unit for use in a television system including a television network and transmitting apparatus for transmitting program schedule information, the subscriber unit including a receiving unit for receiving the program schedule information, a profile storage unit for storing at least one viewer preference profile of at least one television viewer, an intelligent agent for customizing the program schedule information based, at least in part, on the viewer preference profile, to produce a program guide including customized program schedule information, and display apparatus for displaying the program guide.

Published US patent application 2004/0113892 of Mears et al. describes a universal remote control includes a display that is partitioned into a button touch-screen portion and a message area. The button touch-screen portion includes pre-determined or etched areas defining a plurality of buttons and a given number of pre-determined labels for each button. The message area includes individual pixels (i.e. a dot matrix) that allow the display of messages, labels or the like such as text. Activation of a touch-screen button having a message or label associated therewith causes the message or label to be displayed in the message area of the display. The remote control is customizable by the user. The user may configure a label for a particular button to suit user's preference.

U.S. Pat. No. 6,367,078 to Lasky describes an electronic program-guide (EPG) system that enables a viewer of a television program in a particular category to surf sideways to another program in the same category. The EPG system indicates the availability of such other channels carrying programs in the same category in a “channel hat” superimposed on the video at the top of the picture. The channel hat may also contain the channel number, title and category of the program in the channel just selected, and it is displayed for a few seconds. When the viewer presses the right or left-arrow key, the EPG system surfs sideways to the next higher or lower channel carrying a program in the same category as the current program.

The website www.allwatchers.com provides book and movie reviews. A user using the site first fills in a questionnaire regarding various aspects of plot and acceptable level of violence, and a list meeting these preferences is provided.

Digital Video Broadcasting (DVB) Specification for Service Information (SI) in DVB Systems, ETS 300 468 describes a content descriptor that comprises two nibbles of data for content identifiers. The two nibbles of data are used to assign content to a general content category and a more specific content category. For example, content_nibble_level_{—}1 may be:

| | |
|---|---|
| 0x1 | Movie/Drama |
| 0x2 | News/Current Affairs |
| 0x3 | Show/Game show |
| 0x4 | Sports |

and so forth. Content assigned to category 0×4 Sports may be assigned to one of many content_nibble_level_{—}2 sub-categories, including:

| | |
|---|---|
| 0x0 | sports (general) |
| 0x1 | special events (Olympic games, World Cup, etc.) |
| 0x2 | sports magazines |
| 0x3 | football/soccer |
| 0x4 | tennis/squash |

and so forth. (Refer to ETS 300 468, pages 31-34, for a full list.)

The electronic program guide (EPG) in use in set-top boxes for the BSkyB digital satellite broadcasting system in the United Kingdom and Eire allows a user to select the “TV Guide” feature. The TV Guide displays a list of content items sorted by channel and time. The user may sort TV Guide events by category: all channels; movies; entertainment; sports; news; kids; etc. Alternatively, the user may select the “Box Office” feature. The Box Office displays events topically sorted: Movies by Start Time; Movies A-Z (alphabetical sorting of movie titles); New Movies; Sports; etc. Within each category, the user may further elect to view only a given genre of events. For example, within any of the movie categories, the user may use the remote control, signaling the EPG to only display movies by sub-genre: action; science fiction; erotic; comedy; horror; drama; family; thriller; and animation. Within the sports category, the user may use the remote control, signaling the EPG to only display events of specific types: boxing; football; wrestling; and music.

The article “Now Preening on the Coffee Table: The TiVo Remote Control”, published in the New York Times on 19 Feb. 2004, and available on the Internet at www.nytimes.com/2004/02/19/technology/circuits/19remo.html?ex=1392526800&en=450d595187d25d27&ei=5007&partner-USERLAND describes the process by which design engineers at TiVo Inc. designed the remote control unit for the TiVo personal video recorder.

Using a quantitative value, such as a value for a parental control rating, is a well known mechanism in broadcast systems, such as cable and satellite television systems, for blanking out or encrypting channels that exceed the threshold of the quantitative value.

The disclosures of all references mentioned above and throughout the present specification, as well as the disclosures of all references mentioned in those references, are hereby incorporated herein by reference.

### SUMMARY OF THE INVENTION

The present invention in preferred embodiments thereof provides for an enhancement to the utility of remote control devices and methods of selecting content for viewing.

There is thus provided in accordance with a preferred embodiment of the present invention a method of enabling a user to select programs in a personal video recorder environment, the method includes enabling the user to select a program subject category, providing in response to user selection of a program subject category, for subsequent user selection, programs within the selected program subject category, at least one of selected and organized in accordance with past user viewing, and subsequently enabling the user to select among the programs.

Further in accordance with a preferred embodiment of the present invention enabling the user to preselect a plurality of selectable program subject categories.

Still further in accordance with a preferred embodiment of the present invention the subsequently enabling the user to select among the programs includes enabling the user to navigate through the programs within the selected program subject category without requiring presenting to the user a listing of the programs.

Additionally in accordance with a preferred embodiment of the present invention the enabling the user to navigate through the programs includes programs immediately before start of broadcast.

Moreover in accordance with a preferred embodiment of the present invention the enabling the user to navigate through the programs includes navigating through advertisements.

Further in accordance with a preferred embodiment of the present invention the personal video recorder dynamically builds and updates a list of programs within the program subject category.

Still further in accordance with a preferred embodiment of the present invention the providing further includes selecting and organizing programs in accordance with a user profile.

Additionally in accordance with a preferred embodiment of the present invention the enabling the user to select the program subject category is performed by at least one of a manufacturer, a salesman, a technician, a broadcast headend, and the user.

Moreover in accordance with a preferred embodiment of the present invention the method includes the user preselecting a quantitative value, the quantitative value corresponding to a rating associated with each individual one of the programs, the rating of the selected program being exactly one of greater than or equal to, greater than, less than or equal to, and less than, the preselected quantitative value.

Further in accordance with a preferred embodiment of the present invention one program subject category includes programs selected solely on the basis of the user profile and past user viewing.

Still further in accordance with a preferred embodiment of the present invention the subsequently enabling the user to select among said programs is performed by actuating at least one button on a remote control.

Additionally in accordance with a preferred embodiment of the present invention the at least one button on a remote control is operatively associated with the program subject category.

Moreover in accordance with a preferred embodiment of the present invention a user actuation of more than one remote control button causes the user to select a program within all program subject categories associated with all actuated remote control buttons.

Further in accordance with a preferred embodiment of the present invention the program subject category comprises one program.

Still further in accordance with a preferred embodiment of the present invention the user assigns the program to the program subject category.

Additionally in accordance with a preferred embodiment of the present invention the method includes displaying, associated with a remote control button, a name of the program subject category assigned to the remote control button.

Moreover in accordance with a preferred embodiment of the present invention the program subject category is assigned to the remote control button by the broadcast headend.

Further in accordance with a preferred embodiment of the present invention the display is at least one of alpha-numeric, and iconic.

Still further in accordance with a preferred embodiment of the present invention the display includes an electronic display technology.

Additionally in accordance with a preferred embodiment of the present invention the electronic display technology includes one of a LED, a LCD, an OLED, and digital paper.

There is also provided in accordance with another preferred embodiment of the present invention a user operated program subject category selector, a provider, which provides in response to user selection of a program subject category, for subsequent user selection, programs within the selected program subject category, at least one of selected and organized in accordance with past user viewing, and an enabler operative to subsequently enable the user to select among the programs.

### BRIEF DESCRIPTION OF THE DRAWINGS

The present invention will be understood and appreciated more fully from the following detailed description, taken in conjunction with the drawings in which:

FIG. 1 is a simplified pictorial illustration of a system for assigning a program subject category to a given remote control button, constructed and operative in accordance with a preferred embodiment of the present invention;

FIG. 2 is a simplified illustration of an Event Information Table (EIT) in a stream of DVB Service Information (SI) data, useful for understanding the operation of the system of FIG. 1;

FIG. 3 is a simplified illustration of construction of a plurality of program subject category tables, based on information in the EIT, useful for understanding the operation of the system of FIG. 1;

FIG. 4A is a simplified pictorial illustration of a user executing a first selection of a first assigned program subject category button on the remote control in accordance with the system of FIG. 1;

FIG. 4B is a simplified pictorial illustration of the user executing a second selection of the first assigned program subject category button on the remote control in accordance with the system of FIG. 1;

FIG. 5A is a simplified pictorial illustration of an example of the user executing a first selection of a second assigned program subject category button on the remote control in accordance with the system of FIG. 1;

FIG. 5B is a simplified pictorial illustration of the user executing a second selection of the second assigned program subject category button on the remote control in accordance with the system of FIG. 1; and

FIG. 6 is a simplified flowchart illustration of a preferred method of operation of the system of FIG. 1.

### DETAILED DESCRIPTION OF A PREFERRED EMBODIMENT

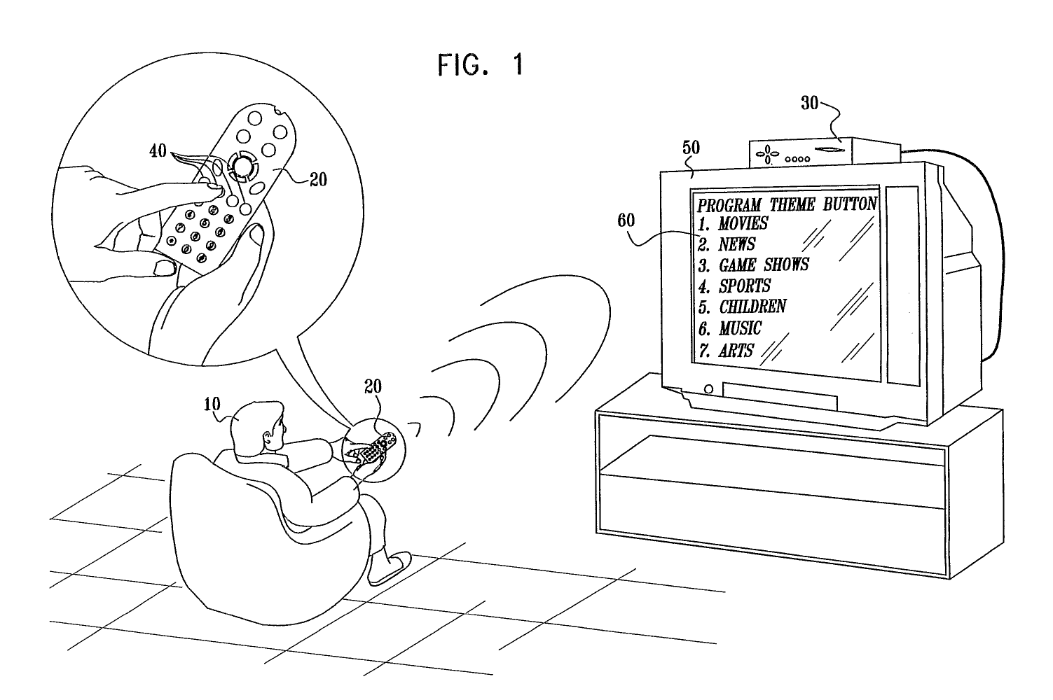

Reference is now made to FIG. 1, which is a simplified pictorial illustration of a system for assigning a program subject category to a given remote control button, constructed and operative in accordance with a preferred embodiment of the present invention. The system of FIG. 1 comprises a set top box remote control 20. A user 10 is shown using the system. The remote control 20 is operatively associated with a set top box 30. The remote control 20 is generally wireless, but may alternatively be connected to the set top box 30 via a cable. It is appreciated that the set top box 30 may preferably comprise a Personal Video Recorder (PVR) or similar device. The set top box 30 is further operatively associated with a television 50. It is appreciated that the set top box 30 may be integrated with the television 50.

The remote control 20 preferably comprises a plurality of buttons 40. Individual buttons among the plurality of buttons 40 are preferably programmed to select a particular program subject category from among a plurality of program subject categories. When one of the plurality of buttons 40 is pressed, the remote control 20 preferably signals the set top box 30 to cause a program of the selected program subject category to appear on the television 50.

The operation of the system of FIG. 1 is now briefly described. The user 10 preferably presses one of the plurality of buttons 40 on the remote control. The system of FIG. 1 is depicted in a state wherein the program subject category for individual buttons among the plurality of buttons 40 is preferably selected. One preferred mechanism for selecting the program subject category is to use a menu 60 that is accessible from an electronic program guide of the set top box 30.

A manufacturer, a salesman, a technician, a broadcast headend, or the user preferably performs the selection and assignment of the program subject category to one of the plurality of the buttons. It is appreciated that, once the particular program subject category from among the plurality of program subject categories is assigned to one of the plurality of buttons 40, the manufacturer, salesman, broadcast headend, or the user may preferably change the selection.

When the user 10 presses one of the plurality of buttons 40, the remote control 20 preferably signals the set top box 30 to cause a program of a selected program subject category to appear on the television 50.

It is appreciated that communication between the remote control 20 and set top box 30 may occur in any appropriate fashion, including, but not limited to RF communication and IR communication.

The term “program” in all of its grammatical forms, as used in the present specification and claims, is understood to mean any video and/or audio content accessible to the set top box 30, including, but not exclusively, material on disk, live broadcast material, material accessed from Internet, and so forth.

It is appreciated that although all of the examples given in the present disclosure focus on a plurality of buttons 40 on a remote control device, these examples are not meant to be limiting. Any appropriate apparatus that enables the user 10 to select a program subject category and convey that selection to the set top box 30 may preferably be used in an alternative preferred embodiment of the present invention. A non-limiting example of such an apparatus would be a personal digital assistant (PDA) operatively associated with the set top box 30 to select a program subject category and convey that selection to the set top box 30. An alternative non-limiting example of such an apparatus would be the buttons on the front panel of the set top box 30.

In order to implement certain preferred embodiments of the present invention, it is necessary to categorize television content into program subject categories. The Digital Video Broadcasting (DVB) Specification for Service Information (SI) (ETS 300 468) describes at length a content descriptor comprising two nibbles of data for content identifiers. These two nibbles of data are used to assign content to a general content category and a more specific content category. For example, content_nibble_level_{—}1 may be:

| | |
|---|---|
| 0x1 | Movie/Drama |
| 0x2 | News/Current Affairs |
| 0x3 | Show/Game show |
| 0x4 | Sports |

and so forth. Content assigned to category 0×4 Sports may be assigned to one of many content_nibble_level_{—}2 sub-categories, including:

| | |
|---|---|
| 0x0 | sports (general) |
| 0x1 | special events (Olympic games, World Cup, etc.) |
| 0x2 | sports magazines |
| 0x3 | football/soccer |
| 0x4 | tennis/squash |

and so forth. (Refer to ETS 300 468, pages 31-34 for the complete list). One preferred method of using the content level nibbles to categorize the television content into program subject categories is described below.

The division of content into program subject categories is preferably according to the categories available in ETS 300 468 or another comparable standard. Alternatively, the division of content may be according to any appropriate non-standard scheme. Similarly, individual buttons among the plurality of buttons 40 may preferably be assigned to the general content category or the more specific content category of ETS 300 468. It is appreciated the present invention is operative where alternative or proprietary methods of dividing content into program subject categories is utilized.

As program guide data is downloaded from a broadcast headend to the set top box 30, the two SI content identifier nibbles become available to the set top box for each program. The set top box preferably continuously and dynamically updates a list of programs for each program subject category so that when one of the plurality of buttons 40 is preferably assigned to the particular program subject category from among the plurality of program subject categories, the user 10 will preferably be provided with content of the selected program subject category with a minimum of delay.

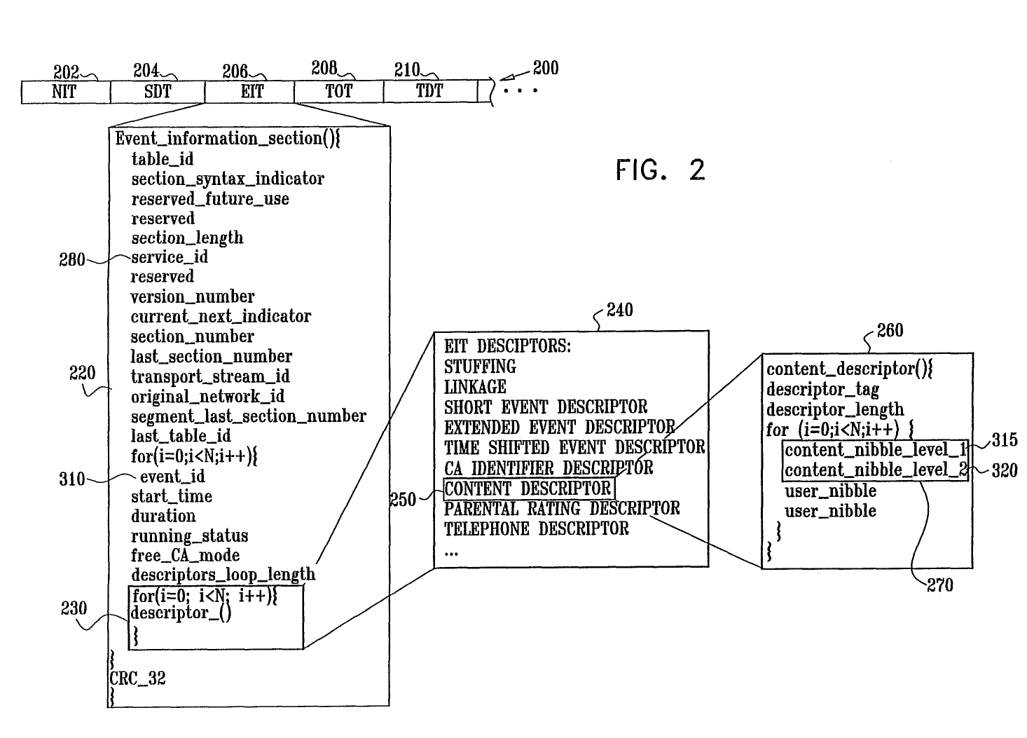

Reference is now additionally made to FIG. 2, which is a simplified illustration of a typical Event Information Table (EIT) in a stream of DVB Service Information (SI) data, useful for understanding the operation of the system of FIG. 1. A full description of SI and SI components is found in ETS 300 468. FIG. 2 shows symbolic representation of a portion of a typical stream 200 of DVB SI. The stream 200 of SI depicted comprises a Network Information Table (NIT) 202, a Service Descriptor Table (SDT) 204, an Event Information Table (EIT) 206, a Time Offset Table (TOT) 208, and a Time and Date Table (TDT) 210. Other SI tables, not depicted in the stream 200 include, but are not limited to a Bouquet Association Table (BAT), a Running Status Table (RST), and a Stuffing Table (ST). The EIT comprises the information 220 shown in FIG. 2 and described in ETS 300 468.

Comprised in the EIT 206 is a service_ID 280, uniquely identifying an SI service for which events are listed in a particular EIT. Also comprised in the EIT 206 is at least one event_ID 310, comprising an identification number, uniquely allocated within the SI service, thereby uniquely identifying an event.

Of particular interest in FIG. 2 is a group of descriptors 230. A partial list of descriptors 240 which typically might be comprised in the EIT 206 includes, but is not limited to: stuffing descriptor, linkage descriptor, short and extended event descriptors, time shifted event descriptor, conditional access identifier descriptor, content descriptor 250, parental rating descriptor, telephone descriptor, and so forth.

The content descriptor 250 is depicted more fully in FIG. 2, and identified by reference numeral 260. The content descriptor 260 comprises a descriptor tag, descriptor length, and two content_level_nibbles 270. The two content_level_nibbles 270 comprise content_nibble_level_{—}1 315 and content_nibble_level_{—}2 320, described above, and one or more nibbles of user data.

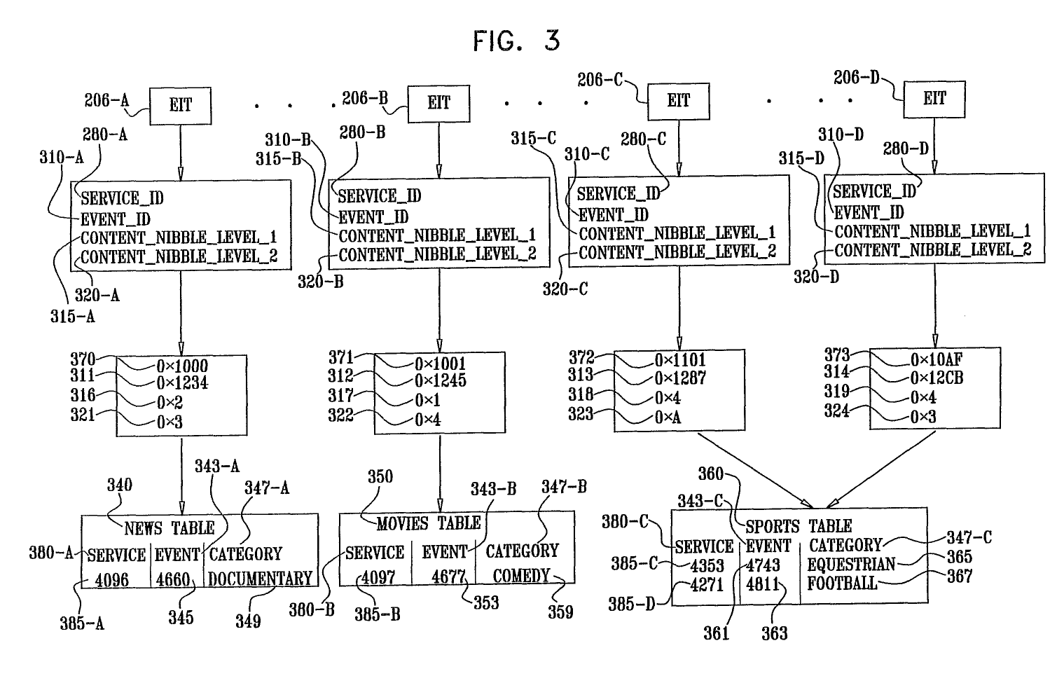

Reference is now additionally made to FIG. 3, which is a simplified illustration of construction of a plurality of program subject category tables, based on information in the EIT 206, useful for understanding the operation of the system of FIG. 1. Several EITs 206-A-206-D are depicted by way of example in FIG. 3. Those skilled in the art will appreciate that an “event,” as used in describing SI, closely corresponds to the term “program” as defined above.

The EIT 206-A comprises a service_ID 280-A, an event ID 310-A, a content_nibble_level_{—}1 315-A, and a content_nibble_level_{—}2 320-A. The event ID 310-A is a 16-bit field in the EIT that is uniquely allocated within a given SI service for each event.

In each of the EITs 206-A-206-D, each of the corresponding content_nibble_level_{—}1 315-A-315-D, and content_nibble_level_{—}2 320-A-320-D translates to a particular set of values. For instance, in the example of FIG. 3, EIT 206-A, service_ID 280-A is 0×1000 370, event_ID 310-A is 0×1234 311, content_nibble_level_{—}1 315-A is 0×2 316, and content_nibble_level_{—}2 320-A is 0×3 321.

Referring, for example to the set top box 30 when processing EIT 206-A, the set top box 30 extracts the service_ID 280-A, the event_ID 310-A, the content_nibble_level_{—}1 315-A, and the content_nibble_level_{—}2 320-A of EIT 206-A, and evaluates the value of the content_level_nibble_{—}1 315-A. In the present example, content_nibble_level_{—}1 315-A is 0×2 316. 0×2 316 translates to news, as explained above, so the event ID 310-A of the event being evaluated, 0×1234 311, or decimal 4660 345 is placed in the event column 343-A of a news table 340. The service_ID 280-A of EIT 206-A, 0×1000 370, or decimal 4096 385-A, is placed in the service column 380-A of the news table 340. The value of content_nibble_level_{—}2 320-A, 0×3 321, within content_nibble_level_{—}1 category 0×2 (News), corresponds to documentary 349. Documentary 349 is entered in the category column 347-A of the news table 340 in the row of event 4660 345.

Similarly, in the example of FIG. 3, the set top box 30 preferably looks up EIT 206-B, and determines that content_nibble_level_{—}1 315-B of EIT 206-B is 0×1 317. Since the value of 0×1 in content_nibble_level_{—}1 translates to movies, as explained above, the set top box 30 preferably places the event_ID 310-B of 0×1245, which is indicated by reference numeral 312 in the movies table 350. The event ID of 310-B, decimal 4677, which is indicated by reference numeral 353, is placed in the event column 343-B of the movies table 350. The value of content_nibble_level_{—}2 320-B, 0×4, which is indicated by reference numeral 322, within content_nibble_level_{—}1 category 0×1 (Movies), evaluates to comedy 359. Comedy 359 is entered by the set top box 30 in the category column 347-B of movies table 350 in the row of event 4677, which is indicated by reference numeral 353. The service_ID 310-B evaluates to 0×1001, which is indicated by reference numeral 371, which translates to decimal 4097, which is indicated by reference numeral 385-B. 4097, which is indicated by reference numeral 385-B is entered by the set top box 30 in the service column 380-B of the movies table 350, in the row of event 4667, which is indicated by reference numeral 353.

In the example given in FIG. 3, EITs 206-C and 206-D both comprise content_nibble_level_{—}1 310-C and 310-D of 0×4, which is indicated by reference numerals 318 and 319. Content_nibble_level_{—}1 315-C and 315-D of 0×4 translates to sports, as explained above.

EIT 206-C has an event_ID 310_C of 0×1287, which is indicated by reference numeral 313. Event_ID 310-C has a decimal value of 4743, which is indicated by reference numeral 361, and is therefore preferably entered in sports table 360. Corresponding service_ID 280-C and content_nibble_level_{—}2 320-C are entered in the sports table 360, in the service column 380-C as decimal 4353 which is indicated by reference numeral 385-C, and in the category column 347-C as equestrian 365, respectively, in the row of event 4743 which is indicated by reference numeral 361.

Likewise, Event_ID 310-D, having a decimal value of 4811, which is indicated by reference numeral 363, is therefore preferably entered in sports table 360. The corresponding service_ID 280-D and content_nibble_level_{—}2 320-D are entered in the sports table 360, in the service column 380-C as decimal 4271, which is indicated by reference numeral 385-D, and in the category column 347-C as football 367, respectively, in the row of event 4811, which is indicated by reference numeral 363.

It is appreciated that the entire preceding discussion of evaluation of values in the EIT is on a symbolic level, and the set top box 30 preferably stores all of the tables, as well as table columns, and rows in a binary format at designated locations in set top box memory. The use of graphic representation in FIGS. 2 and 3, as well as the use of hexadecimal, decimal, and alphanumeric notation in the explanation of FIGS. 2 and 3 is purely for human convenience. It is further appreciated that the tables as described may comprise additional columns, not shown or described for the sake of simplicity of description.

It is appreciated that the tables described above are exemplary. Other tables, for other content_nibble_level_{—}1 values and categories, are preferably created as needed. It is further appreciated that other methods of implementation of preferred embodiments of the present invention are possible, the above description being only one possible method. Persons skilled in the art will appreciate that the tables described above are expandable to comprise other columns of data that may be extracted from the EIT or other SI tables. Adding such columns may enable alternative preferred embodiments, such as, but without limiting the generality of the foregoing, those described elsewhere in the present disclosure. It is further appreciated that the tables described above may be sorted, filtered, and so forth, as is well known in the art.

When the user 10 selects a program subject category, the set top box 30 retrieves an appropriate table for the corresponding program subject category. Based on the stored event ID for a given table entry, the set top box 30 tunes to the program corresponding to a given entry in the appropriate program subject category. For example, and without limiting the generality of the foregoing, if the user 10 presses a program subject category button for the sports category, the set top box 30 preferably cross references the sports table 360 in set top box 30 memory, and determines to which SI service to tune next, in order to preferably display the appropriate event/program.

Returning to the discussion of FIG. 1, as the user 10 accrues a viewing history, the selection of a particular program within a given program subject category may preferably be according to the viewer history. For example, and without limiting the generality of the foregoing, the user may have accrued a history of watching baseball games in which the Chicago Cubs are playing. A preferred embodiment of the present invention would then give precedence to baseball games featuring the Chicago Cubs over other teams when the Sports (or Baseball) program subject category button is pressed. A system whereby the accrued history of user choices is used by a device in making future decisions is described in U.S. Pat. No. 6,637,029 of Maissel et al.

Furthermore, if the user has stored a user profile in which a user preference is defined, the selection of a particular program within a given program subject category may preferably be according to the user preference defined in the user profile. For example, and without limiting the generality of the foregoing, if the user has expressed, in the user profile, a preference to view historical dramas, a preferred embodiment of the present invention would preferably give precedence to historical dramas when the movie program subject category button is pressed. Another non-limiting example of the use of viewer profile would preferably be the showing of material that is deemed to be of interest to viewers in a given age group, socio-economic status, profession, and so forth.

In another preferred embodiment of the present invention, the user preferably assigns one of the plurality of buttons 40 to a category “Recommendations”. When the viewer presses the one of the plurality of buttons assigned to “recommendations”, the set top box 30 preferably displays a program from among all programs available at the present time based solely on user profile and viewing history on the television. For example, and without limiting the generality of the foregoing, pressing the one of the plurality of buttons assigned to “recommendations” causes a game involving the user's favorite team to be displayed. Pressing the one of the plurality of buttons assigned to “recommendations” a second time causes the user's favorite comedy show to appear, and so forth.

It is further appreciated that in some preferred embodiments of the present invention, where buttons on the remote control are assigned to specific program subject categories, an alpha-numeric or iconic display comprised in or near the buttons preferably displays a name of the program subject category assigned to a particular button. For example, and without limiting the generality of the foregoing, the alpha-numeric or iconic display may display “TENNIS” or “DRAMA” as appropriate. The alpha-numeric or iconic display may comprise any appropriate display technology, including, but not limited to one of the following electronic display technologies: a LED, a LCD, an OLED, or “digital paper” (for example, Gyricon™, invented at Xerox PARC, refer to www2.parc.com/dh1/projects/gyricon/). It is appreciated that the display may comprise any other appropriate display technology. It is also further appreciated that the alpha-numeric or iconic display may comprise an appropriate combination of digital display technologies, for example, and without limiting the generality of the foregoing, both LCDs and OLEDs.

In preferred embodiments of the present invention where an alpha-numeric or iconic display comprised in or near the buttons preferably displays the name of the program subject category assigned to a particular button, the program subject category may be assigned to the remote control button by at least one of:

the manufacturer;

the salesman;

the technician;

the broadcast headend; and

the user.

In a preferred embodiment of the present invention, after pressing one of the plurality of buttons 40, a program of the selected program subject category may not appear on the television 50. Rather, the set top box preferably causes a channel to appear on the television 50 which will preferably soon show a program of the selected program subject category.

In another preferred embodiment of the present invention, broadcast material is preferably associated with specific individual buttons of the plurality of buttons 40. For example, and without limiting the generality of the foregoing, an advertiser could preferably pay to have a particular advertisement appear only if the user 10 has pressed a button assigned to a sports program subject category, but not if the user has pressed a button assigned to a news program subject category.

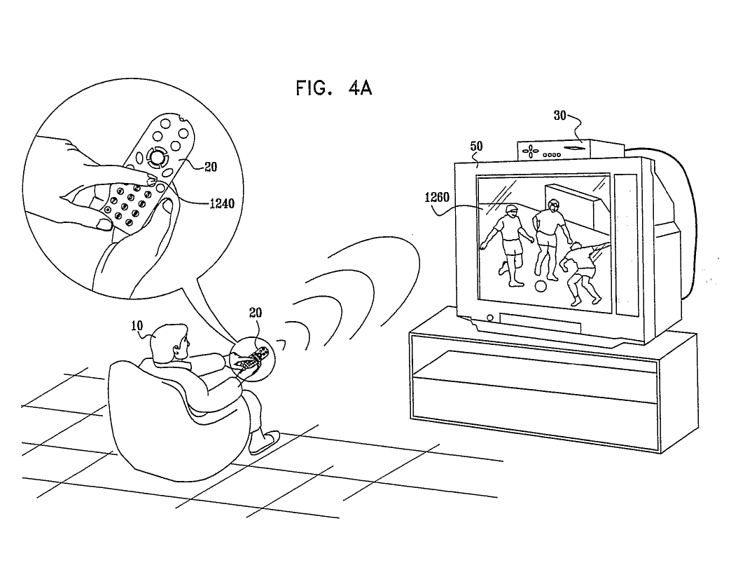

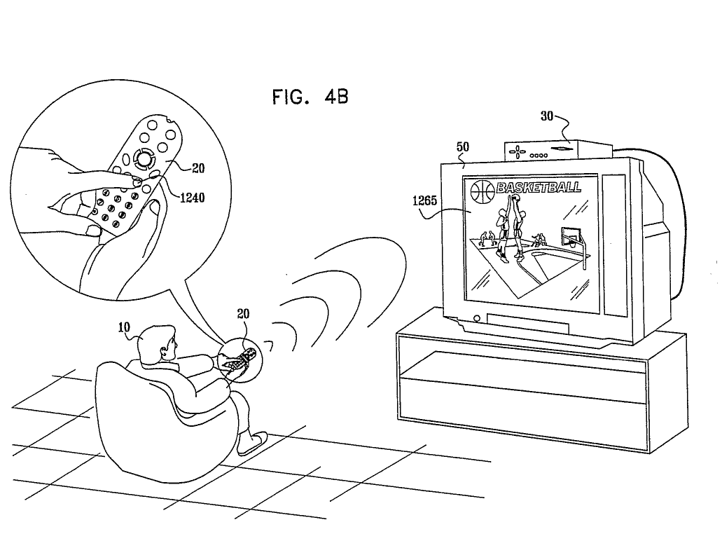

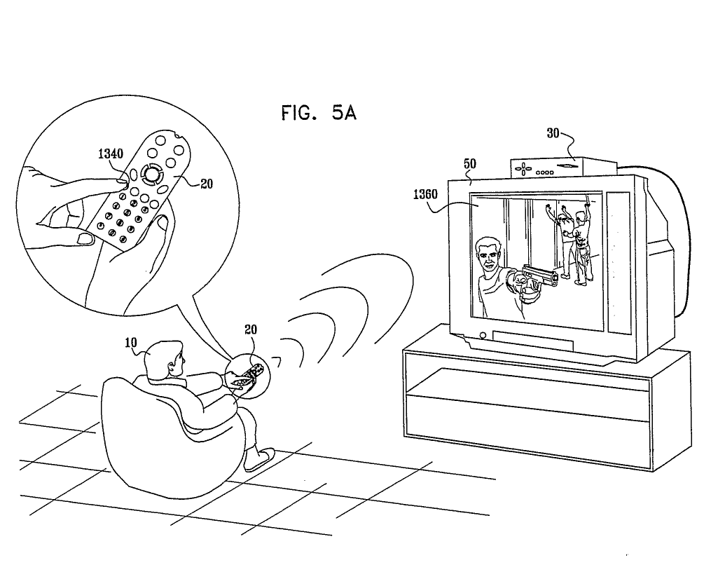

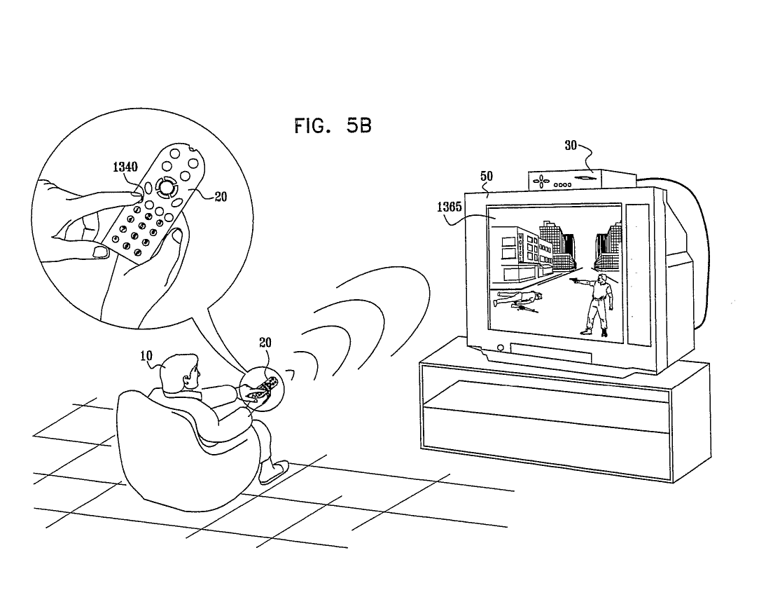

Preferred examples of the use of the system of FIG. 1 are illustrated in FIGS. 4A-5B.

Reference is now made to FIG. 4A, which is a simplified pictorial illustration of the user executing a first selection of a first assigned program subject category button on the remote control in accordance with the system of FIG. 1. The user 10 holds the remote control 20. The user 10 presses a button 1240 on the remote control 20 that has been previously assigned to the sports program subject category. A signal is preferably sent from the remote control 20 to the set top box 30. The signal preferably causes the set top box 30 to display a sports game 1260 on the television 50.

Reference is now made to FIG. 4B, which is a simplified pictorial illustration of the user executing a second selection of the first assigned program subject category button on the remote control in accordance with the system of FIG. 1. FIG. 4B portrays the continuation of the scene portrayed in FIG. 4A. After viewing the sports game 1260 (FIG. 4A) on the television 50, the user decides to view a different sports game. The user 10 presses the button 1240 on the remote control 20 a second time. A signal is preferably sent from the remote control 20 to the set top box 30. The signal preferably causes the set top box 30 to display a second sports game 265 on the television 50.

Reference is now made to FIG. 5A, which is a simplified pictorial illustration of an example of the user executing a first selection of a second assigned program subject category button on the remote control in accordance with the system of FIG. 1. The user 10 holds the remote control 20. The user 10 presses a button 1340 on the remote control 20 that has been previously assigned to the detective subcategory of the movie program subject category. A signal is preferably sent from the remote control 20 to the set top box 30. The signal preferably causes the set top box 30 to display a detective program 1360 on the television 50.

Reference is now made to FIG. 5B, which is a simplified pictorial illustration of the user executing a second selection of the second assigned program subject category button on the remote control in accordance with the system of FIG. 1. FIG. 5B portrays the continuation of the scene portrayed in FIG. 5A. After viewing the detective program 1360 (FIG. 5A) on the television 50, the user decides to view a different detective program. The user 10 presses the button 1340 on the remote control 20 a second time. A signal is preferably sent from the remote control 20 to the set top box 30. The signal preferably causes the set top box 30 to display a second detective program 1365 on the television 50.

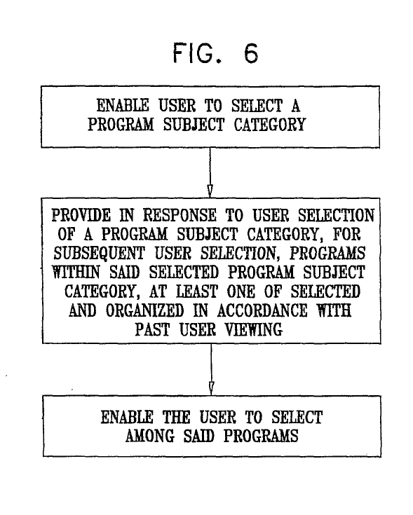

Reference is now made to FIG. 6, which is a simplified flowchart illustration of a preferred method of operation of the system of FIG. 1. The method of FIG. 6 is self-explanatory.

In an alternative preferred embodiment of the present invention (not illustrated), a user-initiated signal from the remote control 20 preferably signals the set top box 30 that the user 10 wishes to receive content that preferably corresponds to a quantitative value. For example, and without limiting the generality of the foregoing, the user 10 could use the remote control 30 to signal that only content of a given parental guidance value or lower is acceptable for display on the television 50. It is appreciated that the user 10 is preferably able to adjust up or down the quantitative value. An alternative example would be to allow the user 10 to specify that only content items having at least a specific popularity rating are acceptable for viewing. It is appreciated that the specification of quantitative values, for example, parental control, acceptable level of violence, and so forth, could preferably be provided in a similar manner as that used for specifying other quantitative parameters such as volume or brightness. Non-limiting examples of methods used for specifying other quantitative parameters comprise a dial or adjustable indicator on a scale. The aforementioned quantitative values preferably serve to further refine the list of programs preferably shown in response to pressing the theme buttons.

In yet another preferred embodiment of the present invention, the user could set a level above or below which content selected using the program subject category button must fall. For example, and without limiting the generality of the foregoing, if the user 10 sets a maximum acceptable parental guidance level of 7, then only content items of the selected program subject category having a parental guidance level of 7 or less would preferably be displayed when the user presses the button corresponding to the desired selected program subject category. In another example, if the user 10 sets a minimum popularity rating to 75, then only content items having a popularity rating greater or equal to 75 would be displayed when the user presses the button corresponding to the desired selected program subject category.

In still another preferred embodiment of the present invention, the user preferably simultaneously presses multiple buttons on the remote control in order to issue an instruction to the set top box that is a combination of the instructions represented by each of the buttons. For example, and without limiting the generality of the foregoing, if a first program subject category button is assigned to children's programming and a second program subject category button is assigned to movies, then simultaneously pressing the first and second program subject category buttons preferably causes the set top box to display a children's movie on the television.

In a further preferred embodiment of the present invention, the user is able to directly associate at least one program with a single remote control button. For example, and without limiting the generality of the foregoing, after selecting the at least one program in the electronic program guide, an <Associate> menu item is preferably selected, or an <Associate> remote control button is preferably pressed. Immediately after selecting the <Associate> menu item or remote control button, a program category selection button is preferably pressed, thereby preferably associating the at least one program with the program category selection button. Alternatively, the <Associate> menu item or remote control button is preferably pressed while watching the at least one program. After selecting the <Associate> menu item or remote control button, a program category selection button is preferably pressed, thereby associating the at least one program with the program category selection button.

When the user has assigned a plurality of programs to program category selection buttons, the set top box preferably itself, using the content_nibble_level_{—}1 and content_nibble_level_{—}2, as described above, assigns other programs with the same content_nibble_level_{—}1 and content_nibble_level_{—}2 as the assigned plurality of programs to program selection buttons.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

1. A method of enabling a user to select programs in a personal video recorder environment, the method comprising:
enabling the user to select a program subject category;
providing in response to user selection of a program subject category, for subsequent user selection, programs within said selected program subject category, at least one of selected and organized in accordance with past user viewing; and
subsequently enabling the user to select among said programs.

2. The method according to claim 1 and also comprising:
enabling the user to preselect a plurality of selectable program subject categories.

3. The method according to claim 1 and wherein the subsequently enabling the user to select among said programs includes enabling the user to navigate through the programs within the selected program subject category without requiring presenting to the user a listing of said programs.

4. The method according to claim 3 and wherein the enabling the user to navigate through the programs comprises programs immediately before start of broadcast.

5. The method according to claim 3 and wherein the enabling the user to navigate through the programs comprises navigating through advertisements.

6. The method according to claim 1 and wherein the personal video recorder dynamically builds and updates a list of programs within the program subject category.

7. The method according to claim 1 and wherein the providing further comprises selecting and organizing programs in accordance with a user profile.

8. The method according to claim 1 and wherein the enabling the user to select the program subject category is performed by at least one of:
a manufacturer;
a salesman;
a technician;
a broadcast headend; and
the user.

9. The method according to claim 1 and also comprising the user preselecting a quantitative value, the quantitative value corresponding to a rating associated with each individual one of said programs, the rating of the selected program being exactly one of:
greater than or equal to;
greater than;
less than or equal to; and
less than;
the preselected quantitative value.

10. The method according to claim 1 and wherein one program subject category comprises programs selected solely on the basis of the user profile and past user viewing.

11. The method according to claim 1 and wherein the subsequently enabling the user to select among said programs is performed by actuating at least one button on a remote control.

12. The method according to claim 11 and wherein the at least one button on a remote control is operatively associated with the program subject category.

13. The method according to claim 12 and wherein a user actuation of more than one remote control button causes the user to select a program within all program subject categories associated with all actuated remote control buttons.

14. The method according to claim 3 and wherein the program subject category comprises one program.

15. The method according to claim 14 and wherein the user assigns the program to the program subject category.

16. The method according to claim 1 and also comprising displaying, associated with a remote control button, a name of the program subject category assigned to the remote control button.

17. The method according to claim 16 and wherein the program subject category is assigned to the remote control button by at least one of:
a manufacturer;
a salesman;
a technician;
a broadcast headend; and
the user.

18. The method according to claim 16 and wherein the display is at least one of:
alpha-numeric; and
iconic.

19. The method according to claim 16 and wherein the display comprises an electronic display technology.

20. The method of claim 19 and wherein the electronic display technology comprises at least one of:
a LED;
a LCD;
an OLED; and
digital paper.

21. Program selection apparatus for use in a personal video recorder environment, comprising:
a user operated program subject category selector;
a provider, which provides in response to user selection of a program subject category, for subsequent user selection, programs within said selected program subject category, at least one of selected and organized in accordance with past user viewing; and
an enabler operative to subsequently enable the user to select among said programs.

22. Program selection apparatus for use in a personal video recorder environment, comprising:
means for selecting program subject category which is user operated;
means for providing in response to user selection of a program subject category, for subsequent user selection, programs within said selected program subject category, at least one of selected and organized in accordance with past user viewing; and
means for subsequently enabling the user to select among said programs.
